(19) United States
(12) Patent Application Publication
(10) Pub. No.: US 2025/0282366 A1
(43) Pub. Date: Sep. 11, 2025

(54) REDUNDANT POWER SUPPLY FOR AUTONOMOUS VEHICLES

(71) Applicant: Torc Robotics, Inc., Blacksburg, VA (US)

(72) Inventors: Makarand Phatak, Blacksburg, VA (US); Akshay Pai Raikar, Blacksburg, VA (US); William Davis, Blacksburg, VA (US); Dakota James Hebert, Blacksburg, VA (US); Joseph R. Fox-Rabinovitz, Blacksburg, VA (US)

(21) Appl. No.: 18/596,473

(22) Filed: Mar. 5, 2024

(51) Int. Cl. B60W 50/023; B60R 16/023; B60R 16/033; B60W 60/00; H02J 9/06

(52) U.S. Cl. CPC B60W 50/023; B60R 16/0231; B60R 16/033; B60W 60/0015; H02J 9/06

(57) ABSTRACT

Disclosed herein is a power management system for autonomous vehicles designed to ensure continuous power supply and operational integrity. The system includes dual power networks and corresponding electrical loads, with a specialized switching mechanism comprising multiple input and output buses, and semiconductor switches. The system's default configuration facilitates the connection of different electrical loads to respective power networks. A processor-equipped switch monitors the power supply through sensors and is capable of detecting any adverse conditions within the power networks. Upon detection, the processor initiates a seamless transition of the electrical loads from the compromised first power network to the second power network, ensuring an uninterrupted power supply. The system provides a robust solution for maintaining power continuity in autonomous vehicles, enhancing their reliability and safety.

### TECHNICAL FIELD

The field of the disclosure relates generally to redundant power supplies and, more specifically, redundant power supplies for autonomous vehicles.

### BACKGROUND OF THE INVENTION

In a non-autonomous vehicle or a semi-autonomous vehicle, such as a non-autonomous truck or a semi-autonomous truck, there is limited need for redundant power supplies to ensure safe operation of the vehicle. If there is a system failure in a non-autonomous vehicle or a semi-autonomous vehicle, the driver is able to independently control the vehicle in a safe manner upon a system failure.

In an autonomous vehicle power must be continuously supplied to the autonomy system to safely operate the vehicle. Accordingly, to safely operate, the power supply for the autonomy system must have safety features to ensure continuous operation of the autonomy system. Incorporating these safety features into existing systems of the autonomous vehicle would streamline the manufacturing process for the autonomous vehicle. Additional safety measures could leverage existing safety systems to provide a standalone power supply to the autonomy system.

Accordingly, there is a need to provide a redundant power supply to an autonomy system. By providing the redundant power supply to the autonomy system, the autonomous vehicle can remain operational during a power system failure.

This section is intended to introduce the reader to various aspects of art that may be related to various aspects of the present disclosure described or claimed below. This description is believed to be helpful in providing the reader with background information to facilitate a better understanding of the various aspects of the present disclosure. Accordingly, it should be understood that these statements are to be read in this light and not as admissions of prior art.

### SUMMARY OF THE INVENTION

One aspect of the present disclosure is a system for switching between power networks on an autonomous vehicle. This system includes a first power network, a second power network, a first electrical load, and a second electrical load. It also includes a switch that features a plurality of input buses coupled to both the first and the second power networks, a plurality of output buses coupled to both the first and second electrical loads, and a plurality of semiconductor switches configured to connect these input and output buses. A default configuration of the semiconductor switches connects the first electric load to the first power network and the second electric load to the second power network. A recovery configuration connects both the first and second electric loads to the second power network. Additionally, the system includes a processor configured to receive sensor data from a power supply sensor associated with the input buses, detect a condition in the first power network based on the sensor data, disconnect the first electric load from the first power network in the default configuration, and reconnect the first electrical load to the second power network to provide an uninterrupted supply of power in the recovery configuration.

Another aspect of the present disclosure is a system for maintaining a continuous power supply. This system includes an array of semiconductor switches connected to a plurality of input buses and electrical loads in a default configuration, a power supply sensor, and a processor. The processor is connected to the array of semiconductor switches and configured to receive sensor data from the power supply sensor. Upon detecting a condition based on the sensor data, the processor transitions the array of semiconductor switches to a recovery configuration.

A further aspect of the present disclosure is a method for switching between power sources. The method involves supplying power to an electrical load from a first power network via a switch connected to a plurality of power networks, detecting a condition in the first power network based on data received from a power supply sensor by a processor at the switch, disconnecting the first power network associated with the condition, connecting the switch to a second power network associated with the plurality of power networks, and powering the electrical load using the second power network. The disconnection of the first power network and the connection to the second power network prevent disruption of the supplied power to the electrical load.

Various refinements exist of the features noted in relation to the above-mentioned aspects. Further features may also be incorporated in the above-mentioned aspects as well. These refinements and additional features may exist individually or in any combination. For instance, various features discussed below in relation to any of the illustrated examples may be incorporated into any of the above-described aspects, alone or in any combination.

### BRIEF DESCRIPTION OF DRAWINGS

The following drawings form part of the present specification and are included to further demonstrate certain aspects of the present disclosure. The disclosure may be better understood by reference to one or more of these drawings in combination with the detailed description of specific embodiments presented herein.

FIG. 1 is a schematic diagram of an autonomous vehicle;

FIG. 2 is a block diagram of an autonomous vehicle;

FIG. 3 is a connection diagram of the redundant power supply;

FIG. 4 is a block diagram of the switch; and

FIG. 5 is a block diagram of an example computing device.

Corresponding reference characters indicate corresponding parts throughout the several views of the drawings. Although specific features of various examples may be shown in some drawings and not in others, this is for convenience only. Any feature of any drawing may be referenced or claimed in combination with any feature of any other drawing.

### DETAILED DESCRIPTION

The following detailed description and examples set forth preferred materials, components, and procedures used in accordance with the present disclosure. This description and these examples, however, are provided by way of illustration only, and nothing therein shall be deemed to be a limitation upon the overall scope of the present disclosure.

In various embodiments, autonomous vehicles are required to meet safety requirements to operate. For example, autonomous vehicles may utilize the automotive safety integrity level (ASIL) system to quantify the capabilities of the autonomous vehicle. This rating system quantifies the level of risk posed by electrical and control systems to a potential safety impact on the autonomous vehicle. The ASIL rating associates the severity and complexity of an issue to the ability to control and remediate the issue. ASIL ratings vary from ASIL-A to ASIL-D with each level representing an increasing level of risk and safety associated with the capability of the autonomous vehicle. ASIL-A systems may pose a low potential for causing harm upon failure of the ASIL-A system that will minimally impact the operation of the autonomous vehicle. ASIL-B systems have a moderate potential for causing harm such that additional safety features are required to detect and mitigate failures of the ASIL-B rated system to maintain operation of the autonomous vehicle. ASIL-C system can pose a significant potential for causing harm and represent a critical safety implication. To meet ASIL-C requirements, extensive safety mechanisms, diagnostics, and redundancies to ensure both reliable and safe operation of the autonomous vehicle. ASIL-D rated systems can result in a catastrophic failure of the autonomous vehicle. Accordingly, ASIL-D rated systems require extensive testing, diagnostics, and redundancies to ensure safe operation of the autonomous vehicle.

To determine which ASIL rating is required, systems of the autonomous vehicle are evaluated based on the severity, exposure, and controllability of errors associated with the system. Accordingly, the severity and exposure of the errors are compared to the controllability of error to determine the required ASIL rating. For example, methodologies such as hazard analysis and risk assessment (HARA), fault tree analysis (FTA), event tree analysis (ETA), and failure modes, effects, and diagnostic analysis (FMEDA) can be used to quantify the ASIL rating required for an autonomous capability.

Once the ASIL rating for an autonomous vehicle capability has been established, The autonomous vehicle can be verified against the requirements of the ASIL safety rating. Accordingly, there may be a need to utilize parts from a lower rated safety capability to provide a capability at a higher safety level rating. In certain embodiments of the present disclosure, components rated at a first safety rating can operate at a higher safety rating with proper testing, diagnostics, and redundancies in place. For example, a plurality of power networks may be rated for a first safety rating (e.g. ASIL-B), however the power management system can still achieve a higher safety rating (e.g. ASIL-D) with proper procedures. In various embodiments of the present disclosure, the system may utilize a switch with an ASIL-D safety rating to power electrical loads from a plurality of ASIL-B power networks. With proper testing, the switch can provide advances diagnostic capabilities and redundancies in the power management system such that the power supplied by the switch can meets ASIL-D requirements. Accordingly, augmenting and enhancing the capabilities of a component enables the ability to utilize components in a system at a higher safety rating. Accordingly, when components are leveraged for a higher safety rating, the safety rating level can be expressed as ASIL (component rating) operation rating (e.g. ASIL-(B)D) to signify how the components of the autonomous vehicle are being utilized.

The system may include a plurality of independent power networks providing power to a power system at a first safety rating. Each of the plurality of power networks may be associated with a safety rating lower than the safety rating required for operation of the power system. A switch may be provided connecting the plurality of power networks to the plurality of electrical loads requiring a higher safety rating than can be provided by an individual power network. The switch mechanism introduces power system redundancy to switch between the plurality of power networks and provide a power supply system to the electrical loads at the heightened safety rating. The switch independently monitors the plurality of power networks to identify a power system failure, wherein the switch can reconfigure the connections between the plurality of the power networks and the plurality of electrical loads such that the plurality of electrical loads can maintain nominal operating status. Accordingly, through independent monitoring and remediation of the plurality of power networks, the system can provide a power supply with increased reliability, corresponding to a higher safety rating than can be provided by the plurality of power networks.

In some embodiments, the system may include a plurality of power networks. A power network may be an electrical system integrated into an autonomous vehicle designed to distribute and manage power across various vehicle subsystems associated with the autonomous vehicle. The power networks may include energy storage systems (e.g. batteries, supercapacitors, etc.) and energy generation systems (e.g. regenerative braking systems, alternators, etc.). As a non-limiting example, the system may include a first power network and a second power network. Each of the plurality of power networks may be independently electrically isolated such that each power network is self-contained and can establish an independent connection to the switch. Accordingly, in some embodiments, each of the plurality of power networks can operate independently. For example, if a condition is detected on the first power network, such as a condition corresponding to anomalous operation of the first power network, the condition generally does not directly impact the second power network. Each of the plurality of power networks may be associated with a safety rating. The safety rating of the plurality of power networks may ensure that the power supplies operate in such a way to maintain safe operation of the autonomous vehicle. As a non-limiting example, each of the plurality of power networks may be rated as an ASIL-B power supply and their combination may yield an ASIL-(B)D power system.

In some embodiments, the system may include a plurality of electrical loads. As a non-limiting example, the system may include a first electrical load and a second electrical load. Each of the plurality of electrical loads may be an independent load. In various embodiments, the plurality of electrical loads may be associated with at least one of a sensor set and a computing system. The first electrical load may include, for example, a primary sensor set and a primary computing system. The second electrical load may include, for example, a secondary or redundant computing system and a secondary or redundant sensor set. The plurality of electrical loads may contribute to operation of the autonomous driving platform.

By way of a non-limiting example, the system includes a switch. The switch may be a transistor-based switch, including gone or more semiconductor devices such as MOSFETS, integrated circuit boards, etc.. Additionally, or alternatively, the switch may be an electromechanical switch. The switch may include a plurality of output buses. The switch may include a plurality of semiconductor switches. The semi-conductor switches may determine the connection of the plurality of input buses to the plurality of output buses. The switches may disconnect an electrical load from a first input bus and reconnect the electrical load to a second input bus.

As a non-limiting example, the switch may connect a first power network to a first electrical load and a second electrical power network to a second electrical load in a first configuration of the switch. The connection of the plurality of power networks to the plurality of electrical loads is determined by the configuration of the plurality of semiconductor switches. In various embodiments, the switch may be a crossover switch. Accordingly, the switch may continuously supply power to the plurality of electrical loads independently from the operation of the plurality of power networks. As a non- limiting example, if there is a condition associated with the first power network in the first configuration of the switch, the switch can reconnect the plurality of semiconductor switches to connect the first electrical load and second electrical load to the second power network in a recovery configuration. Accordingly, the switch can provide a redundancy to the plurality of electrical loads by altering the connection of the plurality of semiconductor switches to connect the plurality of output buses to operational input buses.

The system may include a power supply sensor. The power supply sensor may be connected to the plurality of power networks. In various embodiments, the power supply sensor may monitor the operation of the plurality of power networks to detect a condition associated with the plurality of power networks. The condition detected by the power supply sensor may be associated with the inability to provide adequate power to an electrical load connected to the monitored power network by the switch 360. The condition may be voltage fluctuations, overcurrent conditions, temperature anomalies, short circuits, undervoltage, voltage surges, power interruptions, ground faults, battery degradation, and electromagnetic interference. In various embodiments, the power supply sensor may detect the condition by measuring at least one of: an electrical property of the power network, a temperature associated with the power network, or a moisture level associated with the power network. As a non-limiting example, the power supply sensor may detect a condition associated with the first power supply network. The condition detected by the power supply sensor may be associated with an electrical current or voltage that would be operationally disruptive to the at least one electrical loads. The sensor can then transmit sensor data from the power supply sensor to indicate a condition associated with at least one of the power networks. In various embodiments, the sensor can detect and transmit at least one additional condition associated with the plurality of power networks.

In various embodiments, the system may include a power supply processor. The power supply processor may control the configuration of the switch. The power supply processor may be configured to receive data from the power supply sensor. In various embodiments, the system includes a plurality of sensors. The plurality sensors include various types of sensors associated with an autonomous power supply system. The processor may receive raw data from the power supply sensor and analyze the power supply data to detect a condition associated with the plurality of power networks. Upon detection of a condition, the power supply processor may reconfigure the switch. As a non-limiting example, the power supply processor may disconnect a first electrical load from an input bus associated with the detected power supply condition. The power supply processor may then reconfigure the first electrical load to connect the electrical load to an operational power network, where the operational power network is not associated with a detected condition.

In various embodiments of the present disclosure, the power supply processor enables the plurality of power networks to operate in a manner similar to a safety rated power supply when powering the plurality of electrical loads. As a non-limiting example, the plurality of power supplies connected to the switch may include a first safety rating. The operation of the switch, the power supply sensor, and the power supply processor connected to the plurality of power networks can accordingly operate as a power supply with a higher safety rating. In various embodiments, the plurality of power networks may be ASIL-B rated. The connection of the plurality of power networks to the switch and the operation of the power supply processor in response to the data received from the power supply sensor may function to provide a power supply to the output buses that is functionally similar, if not equivalent, to an ASIL-D rated power supply. The power supply processor may be isolated from the rest of the autonomous vehicle such that the processor functions independently from other system of the autonomous vehicle. The power supply processor may transmit information to other subsystems associated with the autonomous vehicle, however the operation of the processor is unaffected by the operation of the rest of the autonomous vehicle, such as the autonomy system.

The safety rating of the power supply output from the switch may be, at least in part, associated with the ability to provide a continuous power supply to the plurality of electrical loads. The plurality of power networks connected to the switch may enable the power supply sensor and the power supply processor to provide redundant power supplies for the plurality of electrical loads to satisfy the requirements of a higher level of safety rating than provided by the plurality of power networks. To achieve an ASIL safety rating, a system must demonstrate adherence to stringent safety standards by certifying its failure rates and demonstrating fault tolerance capabilities. This certification process includes analysis of the system's design, architecture, and redundancy measures to ensure that it can prevent or respond to failures without compromising safety. For example, to achieve the safety rating, the system must comply with specific failure rate benchmarks and maintain critical safety functions even during component failures (e.g. power supply failure). In some embodiments, the plurality of power networks are ASIL-B rated power supplies. However, when the plurality of power networks are connected to the switch, the processor can configure, or operate, the switch. For example, when the plurality of power networks are connected to the switch, the processor can reconfigure the switch to supply power to the plurality of loads in such a way to comply with ASIL-D safety rating requirements.

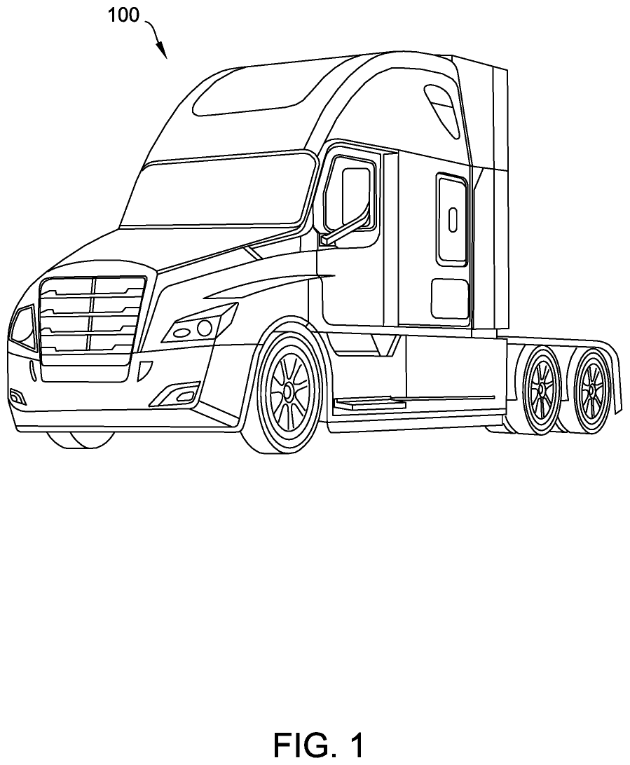

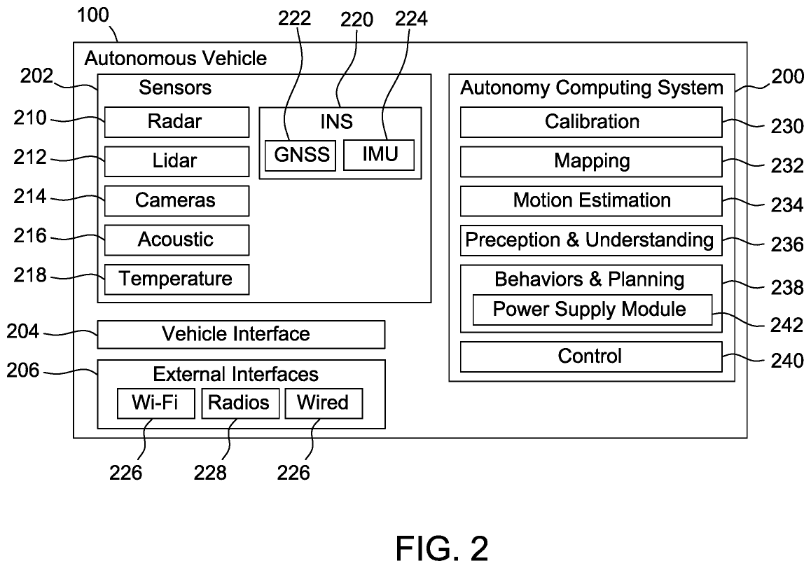

FIG. 1 is a schematic diagram of an autonomous vehicle 100. FIG. 2 is a block diagram of autonomous vehicle 100 shown in FIG. 1. In the example embodiment, autonomous vehicle 100 includes autonomy computing system 200, sensors 202, a vehicle interface 204, and external interfaces 206.

In the example embodiment, sensors 202 may include various sensors such as, for example, radio detection and ranging (RADAR) sensors 210, light detection and ranging (LiDAR) sensors 212, cameras 214, acoustic sensors 216, temperature sensors 218, or inertial navigation system (INS) 220, which may include one or more global navigation satellite system (GNSS) receivers 222 and one or more inertial measurement units (IMU) 224. Other sensors 202 not shown in FIG. 2 may include, for example, acoustic (e.g., ultrasound), internal vehicle sensors, meteorological sensors, or other types of sensors. Sensors 202 generate respective output signals based on detected physical conditions of autonomous vehicle 100 and its proximity. As described in further detail below, these signals may be used by autonomy computing system 120 to determine how to control operation of autonomous vehicle 100.

Cameras 214 are configured to capture images of the environment surrounding autonomous vehicle 100 in any aspect or field of view (FOV). The FOV can have any angle or aspect such that images of the areas ahead of, to the side, behind, above, or below autonomous vehicle 100 may be captured. In some embodiments, the FOV may be limited to particular areas around autonomous vehicle 100 (e.g., forward of autonomous vehicle 100, to the sides of autonomous vehicle 100, etc.) or may surround 360 degrees of autonomous vehicle 100. In some embodiments, autonomous vehicle 100 includes multiple cameras 214, and the images from each of the multiple cameras 214 may be stitched or combined to generate a visual representation of the multiple cameras' FOVs, which may be used to, for example, generate a bird's eye view of the environment surrounding autonomous vehicle 100. In some embodiments, the image data generated by cameras 214 may be sent to autonomy computing system 200 or other aspects of autonomous vehicle 100, and this image data may include autonomous vehicle 100 or a generated representation of autonomous vehicle 100. In some embodiments, one or more systems or components of autonomy computing system 200 may overlay labels to the features depicted in the image data, such as on a raster layer or other semantic layer of a high-definition (HD) map.

LiDAR sensors 212 generally include a laser generator and a detector that send and receive a LiDAR signal such that LiDAR point clouds (or “LiDAR images”) of the areas ahead of, to the side, behind, above, or below autonomous vehicle 100 can be captured and represented in the LiDAR point clouds. Radar sensors 210 may include short-range RADAR (SRR), mid-range RADAR (MRR), long-range RADAR (LRR), or ground-penetrating RADAR (GPR). One or more sensors may emit radio waves, and a processor may process received reflected data (e.g., raw radar sensor data) from the emitted radio waves. In some embodiments, the system inputs from cameras 214, radar sensors 210, or LiDAR sensors 212 may be fused or used in combination to determine conditions (e.g., locations of other objects) around autonomous vehicle 100.

GNSS receiver 222 is positioned on autonomous vehicle 100 and may be configured to determine a location of autonomous vehicle 100, which it may embody as GNSS data, as described herein. GNSS receiver 222 may be configured to receive one or more signals from a global navigation satellite system (e.g., Global Positioning System (GPS) constellation) to localize autonomous vehicle 100 via geolocation. In some embodiments, GNSS receiver 222 may provide an input to or be configured to interact with, update, or otherwise utilize one or more digital maps, such as an HD map (e.g., in a raster layer or other semantic map). In some embodiments, GNSS receiver 222 may provide direct velocity measurement via inspection of the Doppler effect on the signal carrier wave. Multiple GNSS receivers 222 may also provide direct measurements of the orientation of autonomous vehicle 100. For example, with two GNSS receivers 222, two attitude angles (e.g., roll and yaw) may be measured or determined. In some embodiments, autonomous vehicle 100 is configured to receive updates from an external network (e.g., a cellular network). The updates may include one or more of position data (e.g., serving as an alternative or supplement to GNSS data), speed/direction data, orientation or attitude data, traffic data, weather data, or other types of data about autonomous vehicle 100 and its environment.

IMU 224 is a micro-electrical-mechanical (MEMS) device that measures and reports one or more features regarding the motion of autonomous vehicle 100, although other implementations are contemplated, such as mechanical, fiber-optic gyro (FOG), or FOG-on-chip (SiFOG) devices. IMU 224 may measure an acceleration, angular rate, and or an orientation of autonomous vehicle 100 or one or more of its individual components using a combination of accelerometers, gyroscopes, or magnetometers. IMU 224 may detect linear acceleration using one or more accelerometers and rotational rate using one or more gyroscopes and attitude information from one or more magnetometers. In some embodiments, IMU 224 may be communicatively coupled to one or more other systems, for example, GNSS receiver 222 and may provide input to and receive output from GNSS receiver 222 such that autonomy computing system 200 is able to determine the motive characteristics (acceleration, speed/direction, orientation/attitude, etc.) of autonomous vehicle 100.

In the example embodiment, autonomy computing system 200 employs vehicle interface 204 to send commands to the various aspects of autonomous vehicle 100 that actually control the motion of autonomous vehicle 100 (e.g., engine, throttle, steering wheel, brakes, etc.) and to receive input data from one or more sensors 202 (e.g., internal sensors). External interfaces 206 are configured to enable autonomous vehicle 100 to communicate with an external network via, for example, a wired or wireless connection, such as Wi-Fi 226 or other radios 228. In embodiments including a wireless connection, the connection may be a wireless communication signal (e.g., Wi-Fi, cellular, LTE, 5g, Bluetooth, etc.).

In some embodiments, external interfaces 206 may be configured to communicate with an external network via a wired connection 244, such as, for example, during testing of autonomous vehicle 100 or when downloading mission data after completion of a trip. The connection(s) may be used to download and install various lines of code in the form of digital files (e.g., HD maps), executable programs (e.g., navigation programs), and other computer-readable code that may be used by autonomous vehicle 100 to navigate or otherwise operate, either autonomously or semi-autonomously. The digital files, executable programs, and other computer readable code may be stored locally or remotely and may be routinely updated (e.g., automatically or manually) via external interfaces 206 or updated on demand. In some embodiments, autonomous vehicle 100 may deploy with all of the data it needs to complete a mission (e.g., perception, localization, and mission planning) and may not utilize a wireless connection or other connection while underway.

In the example embodiment, autonomy computing system 200 is implemented by one or more processors and memory devices of autonomous vehicle 100. Autonomy computing system 200 includes modules, which may be hardware components (e.g., processors or other circuits) or software components (e.g., computer applications or processes executable by autonomy computing system 200), configured to generate outputs, such as control signals, based on inputs received from, for example, sensors 202. These modules may include, for example, a calibration module 230, a mapping module 232, a motion estimation module 234, a perception and understanding module 236, a behaviors and planning module 238, a control module or controller 240, and a power supply module 242. The power supply module 242, for example, may be embodied within another module, such as behaviors and planning module 238, or separately. These modules may be implemented in dedicated hardware such as, for example, an application specific integrated circuit (ASIC), field programmable gate array (FPGA), or microprocessor, or implemented as executable software modules, or firmware, written to memory and executed on one or more processors onboard autonomous vehicle 100.

Autonomy computing system 200 of autonomous vehicle 100 may be completely autonomous (fully autonomous) or semi-autonomous. In one example, autonomy computing system 200 can operate under Level 5 autonomy (e.g., full driving automation), Level 4 autonomy (e.g., high driving automation), or Level 3 autonomy (e.g., conditional driving automation). As used herein the term “autonomous” includes both fully autonomous and semi-autonomous.

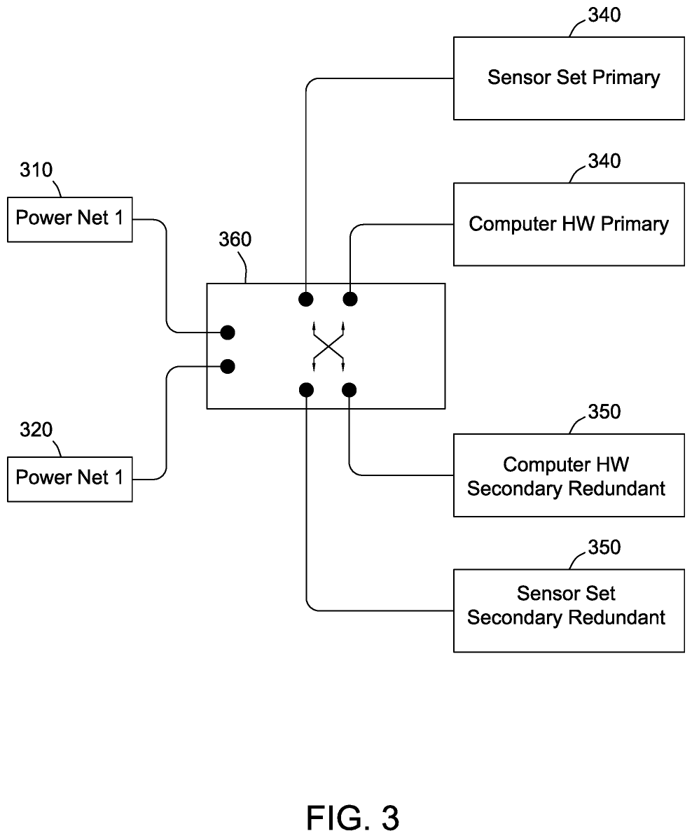

FIG. 3 is a connection diagram of a continuous power supply 300. Continuous power supply system 300 includes a switch 360 configured to connect a plurality of input buses 370 and a plurality of output buses 380. The plurality of input buses 370 connect the switch 360 to a first power network 310 and a second power network 320. The plurality of output buses 380 connect the switch 360 to a first electrical load 340 and a second electrical load 350. Each of the plurality of electrical loads may include one or more computing systems or one or more sensor sets, or a combination of both. The compute hardware may be a compute module. In various embodiments, the plurality of electrical loads may be associated with the operation of the autonomous vehicle. In various embodiments, the switch 360 can be configured to power the plurality of electrical loads when there is a condition associated with at least one of the power networks. For example the condition may correspond to: voltage fluctuations, overcurrent conditions, temperature anomalies, short circuits, undervoltage, voltage surges, power interruptions, ground faults, battery degradation, and electromagnetic interference. Accordingly, the switch 360 ensures continuous supply of power to the plurality of electrical loads by configuring the connections between the plurality of power networks and the plurality of electrical loads to provide redundancies to power the plurality of electrical loads.

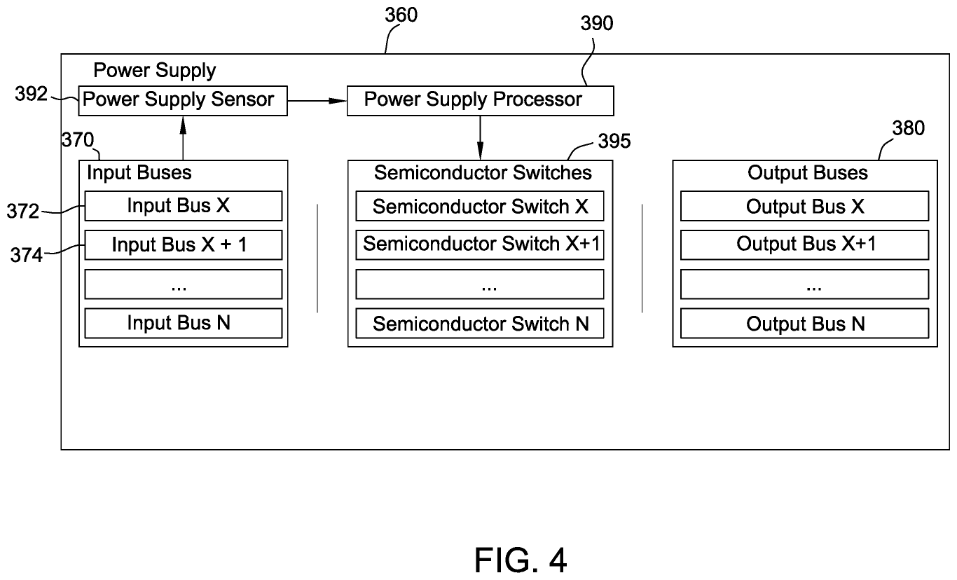

FIG. 4 is a schematic diagram of the switch 360 shown in FIG. 3. The switch 360 includes plurality of input buses 370. Each of the plurality of input buses 370 may be connected to a power network. For example, a first input 372 bus connects to the first power network 310 and a second input bus 374 connect to the second power network 320 as shown in FIG. 3. The connection between the power network and the plurality of input buses 370 electrically connects the power networks to the switch 360. The plurality of input buses 370 connect, for example, to a plurality of semiconductor switches 395. The semiconductor switches 395 connect the plurality of input buses 370 to the plurality of output buses 380. The semiconductor switches 395 are configurable such that the configuration of the semiconductor switches 395 controls the connection between the plurality of input buses 370 and the plurality of output buses 380. In various embodiments, the configuration of the semiconductor switches 395 is implemented by the power supply processor 390. The power supply processor 390 may receive power supply sensor data from the power supply sensor 392 to determine the appropriate configuration of the semiconductor switches 395 connecting the plurality of input buses 370 to the plurality of output buses 380.

As a non-limiting example, a first input bus may be connected to a first power network 310 and a second input bus may be connected to a second power second power network 320. The semiconductor switches 395 may connect the first input bus to a first output bus to power a first electrical load 340 and connect the second input bus to a second output bus to power a second electrical load 350 in a default state. Upon detection of a condition associated with the first power network 310 from the power supply data captured by the power supply sensor 392, the power supply processor 390 may alter the connections of the semiconductor switches 395 to disconnect the first electrical load 340 from the first power network 310. The power supply processor 390 may then reconnect the output bus associated with the first electrical load 340 to the second input bus in a recovery configuration. Accordingly, the power supply processor 390 can configure the switch 360 to provide a redundant power supply. In this way, the electrical loads can be powered by a redundant power supply to provide level 4 autonomy to the autonomous system. The ability for the switch 360 to supply continuous power to the electrical loads enables the high degree of autonomy for the system by ensuring that the electrical loads maintain nominal operating status.

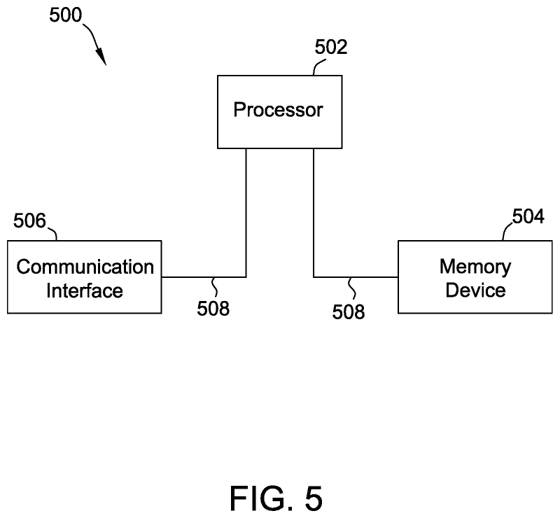

FIG. 5 is a block diagram of an example computing device 500. Computing device 500 includes a processor 502 and a memory device 504. In various embodiments, the computing device 500 includes the power supply processor 390. In various embodiments, the computing device 500 is the power supply processor 390 associated with the switch 360. The processor 502 is coupled to the memory device 504 via a system bus 508. The term “processor” refers generally to any programmable system including systems and microcontrollers, reduced instruction set computers (RISC), complex instruction set computers (CISC), application specific integrated circuits (ASIC), programmable logic circuits (PLC), and any other circuit or processor capable of executing the functions described herein. The above examples are example only, and thus are not intended to limit in any way the definition or meaning of the term “processor.”

In the example embodiment, the memory device 504 includes one or more devices that enable information, such as executable instructions or other data (e.g., sensor data), to be stored and retrieved. Moreover, the memory device 504 includes one or more computer readable media, such as, without limitation, dynamic random access memory (DRAM), static random access memory (SRAM), a solid state disk, or a hard disk. In the example embodiment, the memory device 504 stores, without limitation, application source code, application object code, configuration data, additional input events, application states, assertion statements, validation results, or any other type of data. The computing device 500, in the example embodiment, may also include a communication interface 506 that is coupled to the processor 502 via system bus 508. Moreover, the communication interface 506 is communicatively coupled to data acquisition devices.

In the example embodiment, processor 502 is programmed by encoding an operation using one or more executable instructions and providing the executable instructions in the memory device 504. In the example embodiment, the processor 502 is programmed to select a plurality of measurements that are received from data acquisition devices.

In operation, a computer executes computer-executable instructions embodied in one or more computer-executable components stored on one or more computer-readable media to implement aspects of the disclosure described or illustrated herein. The order of execution or performance of the operations in embodiments of the disclosure illustrated and described herein is not essential, unless otherwise specified. That is, the operations may be performed in any order, unless otherwise specified, and embodiments of the disclosure may include additional or fewer operations than those disclosed herein. For example, it is contemplated that executing or performing a particular operation before, contemporaneously with, or after another operation is within the scope of aspects of the disclosure.

An example technical effect of the methods, systems, and apparatus described herein includes at least one of: providing a redundant power supply, operating a plurality of power networks to comply with safety standards, and ensuring safe and continuous operation of an autonomous vehicle.

Some embodiments involve the use of one or more electronic processing or computing devices. As used herein, the terms “processor” and “computer” and related terms, e.g., “processing device,” and “computing device” are not limited to just those integrated circuits referred to in the art as a computer, but broadly refers to a processor, a processing device or system, a general purpose central processing unit (CPU), a graphics processing unit (GPU), a microcontroller, a microcomputer, a programmable logic controller (PLC), a reduced instruction set computer (RISC) processor, a field programmable gate array (FPGA), a digital signal processor (DSP), an application specific integrated circuit (ASIC), and other programmable circuits or processing devices capable of executing the functions described herein, and these terms are used interchangeably herein. These processing devices are generally “configured” to execute functions by programming or being programmed, or by the provisioning of instructions for execution. The above examples are not intended to limit in any way the definition or meaning of the terms processor, processing device, and related terms.

The various aspects illustrated by logical blocks, modules, circuits, processes, algorithms, and algorithm steps described above may be implemented as electronic hardware, software, or combinations of both. Certain disclosed components, blocks, modules, circuits, and steps are described in terms of their functionality, illustrating the interchangeability of their implementation in electronic hardware or software. The implementation of such functionality varies among different applications given varying system architectures and design constraints. Although such implementations may vary from application to application, they do not constitute a departure from the scope of this disclosure.

Aspects of embodiments implemented in software may be implemented in program code, application software, application programming interfaces (APIs), firmware, middleware, microcode, hardware description languages (HDLs), or any combination thereof. A code segment or machine-executable instruction may represent a procedure, a function, a subprogram, a routine, a subroutine, a module, a software package, a class, or any combination of instructions, data structures, or program statements. A code segment may be coupled to, or integrated with, another code segment or an electronic hardware by passing or receiving information, data, arguments, parameters, memory contents, or memory locations. Information, arguments, parameters, data, etc. may be passed, forwarded, or transmitted via any suitable means including memory sharing, message passing, token passing, network transmission, etc.

The actual software code or specialized control hardware used to implement these systems and methods is not limiting of the claimed features or this disclosure. Thus, the operation and behavior of the systems and methods were described without reference to the specific software code being understood that software and control hardware can be designed to implement the systems and methods based on the description herein.

When implemented in software, the disclosed functions may be embodied, or stored, as one or more instructions or code on or in memory. In the embodiments described herein, memory includes non-transitory computer-readable media, which may include, but is not limited to, media such as flash memory, a random access memory (RAM), read-only memory (ROM), erasable programmable read-only memory (EPROM), electrically erasable programmable read-only memory (EEPROM), and non-volatile RAM (NVRAM). As used herein, the term “non-transitory computer-readable media” is intended to be representative of any tangible, computer-readable media, including, without limitation, non-transitory computer storage devices, including, without limitation, volatile and non-volatile media, and removable and non-removable media such as a firmware, physical and virtual storage, CD-ROM, DVD, and any other digital source such as a network, a server, cloud system, or the Internet, as well as yet to be developed digital means, with the sole exception being a transitory propagating signal. The methods described herein may be embodied as executable instructions, e.g., “software” and “firmware,” in a non-transitory computer-readable medium. As used herein, the terms “software” and “firmware” are interchangeable and include any computer program stored in memory for execution by personal computers, workstations, clients, and servers. Such instructions, when executed by a processor, configure the processor to perform at least a portion of the disclosed methods.

As used herein, an element or step recited in the singular and proceeded with the word “a” or “an” should be understood as not excluding plural elements or steps unless such exclusion is explicitly recited. Furthermore, references to “one embodiment” of the disclosure or an “exemplary” or “example” embodiment are not intended to be interpreted as excluding the existence of additional embodiments that also incorporate the recited features. Likewise, limitations associated with “one embodiment” or “an embodiment” should not be interpreted as limiting to all embodiments unless explicitly recited.

Disjunctive language such as the phrase “at least one of X, Y, or Z,” unless specifically stated otherwise, is generally intended, within the context presented, to disclose that an item, term, etc. may be either X, Y, or Z, or any combination thereof (e.g., X, Y, or Z). Likewise, conjunctive language such as the phrase “at least one of X, Y, and Z,” unless specifically stated otherwise, is generally intended, within the context presented, to disclose at least one of X, at least one of Y, and at least one of Z.

The disclosed systems and methods are not limited to the specific embodiments described herein. Rather, components of the systems or steps of the methods may be utilized independently and separately from other described components or steps.

This written description uses examples to disclose various embodiments, which include the best mode, to enable any person skilled in the art to practice those embodiments, including making and using any devices or systems and performing any incorporated methods. The patentable scope is defined by the claims and may include other examples that occur to those skilled in the art. Such other examples are intended to be within the scope of the claims if they have structural elements that do not differ from the literal language of the claims, or if they include equivalent structural elements with insubstantial differences form the literal language of the claims.

What is claimed is:

1. A system for switching between power networks on an autonomous vehicle, the system comprising:
a first power network;
a second power network;
a first electrical load;
a second electrical load,
wherein the first electrical load and the second electrical load each comprises at least one of a sensor or a computing system; and
a switch comprising:
a plurality of input buses coupled to the first power network and the second power network;
a plurality of output buses coupled to the first electrical load and the second electrical load; and
a plurality of semiconductor switches configured to connect the plurality of input buses and the plurality of output buses,
wherein a default configuration of the plurality of semiconductor switches connects the first electric load to the first power network and the second electric load to the second power network, and
wherein a recovery configuration of the plurality of semiconductor switches connects the first electric load and the second electric load to the second power network; and
a processor configured to:
receive sensor data from a power supply sensor associated with the plurality of the input buses;
detect a condition, based on the sensor data, in the first power network;
disconnect the first electric load from the first power network in the default configuration; and
reconnect, by configuring the plurality of semiconductor switches, the first electrical load to the second power network to provide an uninterrupted supply of power to first electric load in the recovery configuration.

2. The system of claim 1, wherein the sensor comprises at least one of: a radar sensor, a liDAR sensor, a camera, an acoustic sensor, a temperature sensor, or an inertial navigation system, and wherein the computing system is an autonomy computing system configured to operate an autonomous driving platform.

3. The system of claim 1, wherein the processor transmits instructions to the plurality of semiconductor switches to control the configuration of the plurality of semiconductor switches.

4. The system of claim 1, wherein the processor modifies power distribution to the first electrical load and the second electrical load such that the uninterrupted supply of power is compliant with ASIL-D requirements for a redundant power supply.

5. The system of claim 1, wherein the first power network and the second power network are ASIL-B rated.

6. The system of claim 1, wherein the sensor data is at least one of, a current, a voltage, a moisture level, or temperature.

7. The system of claim 1, wherein the processor is further configured to transmit an indication associated with the condition to an autonomous driving platform to assist in operation of the autonomous vehicle.

8. The system of claim 1, further comprising a battery connected to the plurality of semiconductor switches.

9. The system of claim 8, wherein the plurality of semiconductor switches are configured to connect the battery to the first electrical load and the second electrical load in response to detecting an additional condition associated with the first power network and the second power network.

10. A system for maintaining a continuous power supply, the system comprising:
an array of semiconductor switches connected to a plurality of input buses and a plurality of electrical loads associated with an autonomous driving platform in a default configuration, wherein each of the plurality of electrical loads comprise at least one of a sensor or a computing system;
a power supply sensor; and
a processor connected to the array of semiconductor switches and configured to receive sensor data from the power supply sensor, wherein the processor transitions the array of semiconductor switches to a recovery configuration upon detection of a condition based on the sensor data.

11. The system of claim 10, wherein the sensor comprises at least one of: a radar sensor, a liDAR sensor, a camera, an acoustic sensor, a temperature sensor, or an inertial navigation system, and wherein the computing system is an autonomy computing system configured to operate an autonomous driving platform.

12. The system of claim 11, wherein the default configuration of the array of semiconductor switches comprises:
a first input bus of the plurality of input buses connected to a first electrical load of the plurality of electrical loads, and
a second input bus of the plurality of input buses connected to a second electrical load of the plurality of electrical loads; and
wherein the recovery configuration of the array of semiconductor switches comprises:
the first input bus connected to the second electrical load, and
the second input bus connected to the second electrical load.

13. The system of claim 10, wherein the processor modifies a power distribution within the array of semiconductor switches to the plurality of electrical loads to provide a redundant power supply compliant with ASIL-D requirements.

14. The system of claim 12, wherein the processor receives sensor data from the power supply sensor comprising at least one of: a current, a voltage, a moisture level, or a temperature.

15. The system of claim 10, wherein the processor transmits an indication associated with the connection of the array of semiconductor switches and the plurality of electrical loads to an autonomous driving platform.

16. A method for switching between power sources, the method comprising:
supplying power to an electrical load from a first power network via a switch connected to a plurality of power networks;
detecting, from a processor at the switch, a condition in the first power network based on data received from a power supply sensor;
disconnecting the first power network associated with the condition;
connecting the switch to a second power network associated with the plurality of power networks; and
powering the electrical load using the second power network, wherein the disconnection of the first power network and the connection to the second power network prevents disruption of the supplied power to the electrical load.

17. The method of claim 16, further comprising modifying power distribution of the switch to provide a continuous output resembling an ASIL-D rated power supply.

18. The method of claim 16, wherein the processor receives sensor data from the sensor associated with the condition, the sensor data comprising: a current, a voltage, a moisture level, or a temperature.

19. The method of claim 16, wherein the switch is connected to at least one of: a sensor set or a compute module.

20. The method of claim 16, further comprising transmitting an indication associated with the condition in the first power network from the processor to an autonomous driving platform.
